(19) United States
(12) Patent Application Publication
(10) Pub. No.: US 2015/0019642 A1
(43) Pub. Date: Jan. 15, 2015

(54) CALENDAR-EVENT RECOMMENDATION SYSTEM

(71) Applicant: Papaya Mobile, Inc., Beijing (CN)

(72) Inventors: Tianxiong WANG, Beijing (CN); Kunliang ZHAO, Beijing (CN); Si SHEN, Beijing (CN)

(21) Appl. No.: 14/326,931

(22) Filed: Jul. 9, 2014

Related U.S. Application Data
(60) Provisional application No. 61/845,049, filed on Jul. 11, 2013.

(51) Int. Cl. H04L 29/08

(52) U.S. Cl. CPC H04L 67/22; H04L 67/18
USPC 709/204

(57) ABSTRACT

A calendar-event recommendation system that generates and displays event recommendations tailored to a user. The system may recommend events based on a user's current location. The system may recommend events based on a user's social network, such as if the user's friends attend an event, or an event organized by or affiliated with a person, place, or organization the user has interest in. The system may recommend events based on receiving an invitation from others, or if the user's contacts are in the event's guest list. The system may recommend events based on the user's past behavior, such as attending similar events. The system may recommend events based on a user's subscription to categories of certain types of events. After recommending an event, the system may automatically add the event to the user's calendar, add the user's name to a guest list, and share the event with the user's contacts.

### CROSS-REFERENCE TO RELATED APPLICATION

This application claims the benefit of U.S. Provisional Application No. 61/845,049, filed Jul. 11, 2013, which is incorporated herein by reference.

### BACKGROUND

Many people use technology to assist them in scheduling their daily activities. People use calendars on their computers, tablets, smartphones, and anywhere else they can access the internet. People also are interested in connecting with others. Social networks allow people to maintain friendships with many more people than was possible without technology. There will always be a need for improved ways to schedule peoples' lives and improve their connections with other people.

### SUMMARY

The following summary is for illustrative purposes only, and is not intended to limit or constrain the detailed description.

An event-recommendation system may assist a user in discovering events that the user may be interested in attending based on one or more factors. For example, the event-recommendation system may consider the user's current location, available time slots, interests, past events, events attended or hosted by the user's contacts, or other factors. The event-recommendation system may be implemented in a calendar application that runs on the user's smartphone, tablet, computer, or other device. The event recommendation system may also be implemented as a desktop application, a web page, on a server, or in another manner known to one of skill in the art.

In some embodiments, the event-recommendation system may perform a method including detecting, by a computing device, a current location of the user, transmitting a request for a list of events to a social network on which the user has a profile, receiving, in response to the request, the list of events from the social network, determining a location of each event of the list of events, determining one or more nearby events from the list of events within a threshold distance of the current location of the user by comparing the location of each event of the list of events to the current location of the user, recommending the one or more nearby events to the user, receiving, from the user, a selection of a first event from the one or more nearby events, and adding the first event to a calendar of the user, wherein the calendar is not provided by the social network.

In some embodiments, the event-recommendation system may be implemented as a system including one or more processors, and non-transitory computer-readable memory storing computer-readable instructions that, when executed by the one or more processors, cause the system to perform steps described herein. In some embodiments, the event-recommendation system may be implemented as a non-transitory computer-readable medium storing computer-readable instructions that, when executed, cause a device to perform steps described herein.

The summary here is not an exhaustive listing of the novel features described herein, and are not limiting of the claims. These and other features are described in greater detail below.

### BRIEF DESCRIPTION OF THE DRAWINGS

These and other features, aspects, and advantages of the present disclosure will become better understood with regard to the following description, claims, and drawings. The present disclosure is illustrated by way of example, and not limited by, the accompanying drawings in which like numerals indicate similar elements.

FIG. 1A illustrates an example computing device that may be used to implement various features described herein.

FIG. 1B illustrates an example object that may be used to store information about an event according to various features described herein.

FIG. 2 illustrates an example user interface for interacting with a user calendar according to various features described herein.

FIG. 3 illustrates an example user interface for displaying recommended nearby events according to various features described herein.

FIG. 4 illustrates an example system and process flow for implementing various features described herein.

FIG. 5 illustrates an example system and process flow for implementing various features described herein.

FIG. 6 illustrates an example process flow for implementing various features described herein.

FIG. 7 illustrates an example process flow for implementing various features described herein.

FIG. 8 illustrates an example process flow for implementing various features described herein.

FIG. 9 illustrates an example user interface for interacting with a user calendar according to various features described herein.

FIG. 10 illustrates an example user interface for displaying recommended nearby events according to various features described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. Other embodiments may be utilized, and structural and functional modifications may be made, without departing from the scope of the present disclosure.

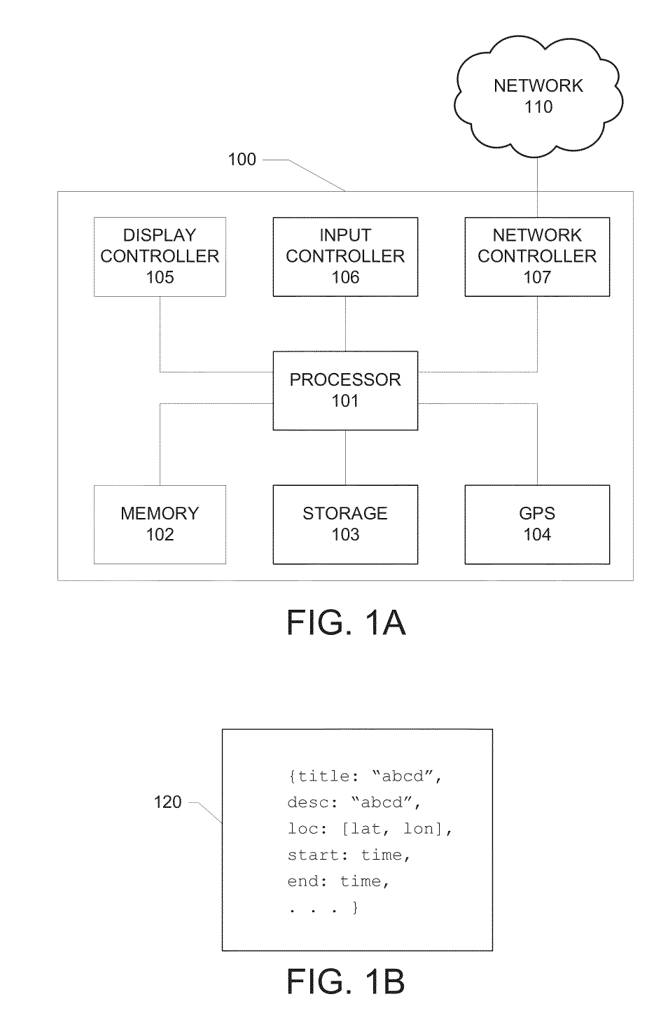

FIG. 1A depicts an illustrative computing device for discovering or recommending events in accordance with one or more example embodiments. Referring to FIG. 1A, computing device 100 may be any type of computing device—or combination thereof—capable of performing the functions described herein. For example, computing device 100 may be a server, server blade, desktop computer, laptop computer, tablet computer, smartphone, mobile device, personal digital assistant, or the like.

Computing device 100 may include one or more processors 101. Processors 101 may be connected to and in communication with memory 102 by a data bus. Memory 102 may include one or more program modules including executable instructions that when executed by one or more processors 101 cause or configure computing device 100 to perform one or more functions described herein.

Processors 101 may be connected to storage 103 by the data bus. Storage 103 may hold data associated with one or more functions described herein.

Processors 101 may be connected to a location device, such as global positioning system (GPS) radio 104. GPS radio 104 may detect location information about a current location of computing device 100.

Processors 101 may be connected to display controller 105. Display controller 105 may control the input or output of information to a display connected to computing device 100. For example, display controller 105 may be connected to a touch-sensitive screen, which may display information to a user of computing device 100.

Processors 101 may be connected to input controller 106. Input controller 106 may communicate with one or more input devices connected to computing device 100. For example, input controller 106 may be connected to the touch-sensitive screen that may also be connected to display controller 105. The touch-sensitive screen may receive input from the user of computing device 100. For example, the touch-sensitive screen may include a virtual keyboard, which the user may use to enter information. In additional examples, input controller 106 may be connected to a keyboard, mouse, stylus, or other input devices known in the art.

Processors 101 may be connected to network controller 107. Network controller 107 may communicate with network 110. Network 110 may be a local network, an enterprise network, a wide-area network, the Internet, or another network.

Computing device 100 may include or be connected to other controllers or devices known to one of skill in the art that may be useful for implementing the various features described herein. For example, computing device 100 may include BLUETOOTH, WIFI, near-field communication (NFC), or additional controllers for communicating with other devices.

FIG. 1B depicts an illustrative embodiment of an event object for storing information about an event. An event object (e.g., object 120) may be stored in an event database on computing device 100, may be added to a calendar linked with a calendar application (e.g., GOOGLE calendar), or otherwise stored in a manner familiar to one of skill in the art.

An event object (e.g., object 120) may include various information about the event (e.g., the information added when the event was created, or information added after the event was created). In object 120, the loc field may indicate the latitude and longitude of an event's location. A Unix timestamp for the event's start and end times may be stored in the start and end fields. The event title or name may be stored in title. A description, notes, user comments, or additional information about the event may be stored in the desc field.

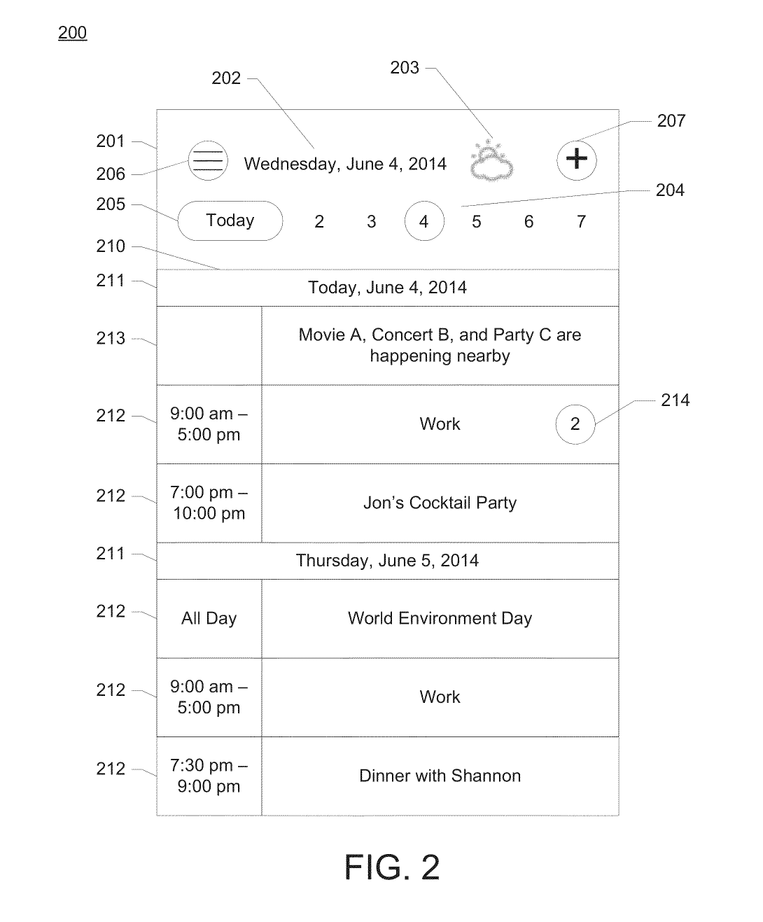

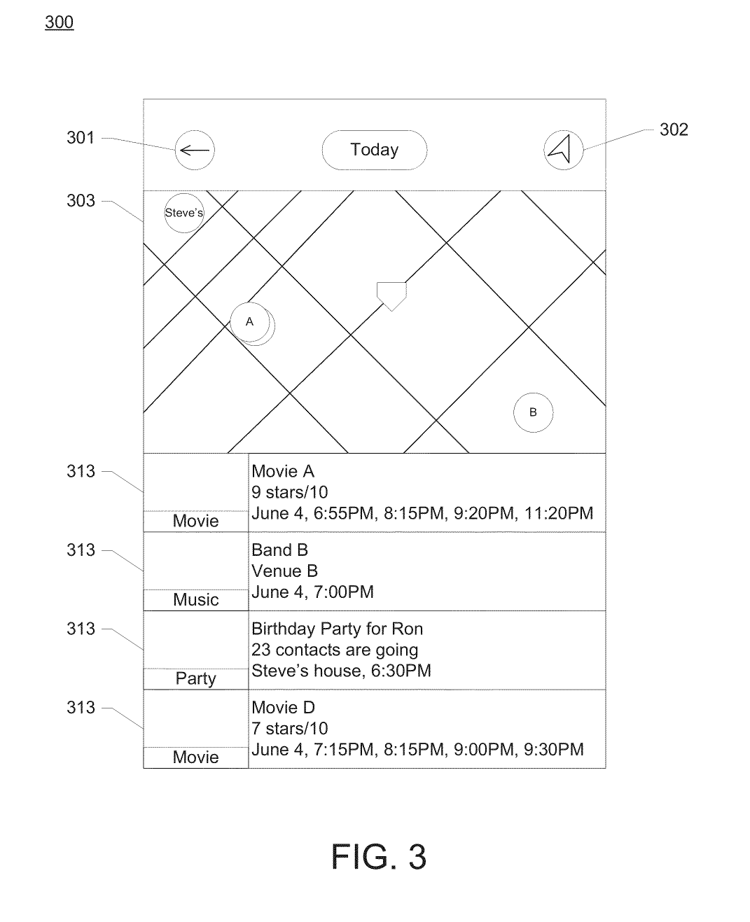

FIG. 2 depicts user interface of an illustrative embodiment of a calendar application configured with one or more of the features described herein. The calendar application may be operable on computing device 100. For example, the calendar application may run on a smartphone, tablet, laptop, or desktop computer. The calendar application may include multiple screens. For example, the calendar application may include a home screen that may include user interface 200. The calendar application may include other screens, such as the screen depicted in FIG. 3.

The calendar application may be linked to one or more calendars of a user. For example, a user may log into the calendar application with the user's GOOGLE calendar, the user's work calendar (e.g., MICROSOFT EXCHANGE calendar), the user's ICLOUD calendar, and the user's social-media account (e.g., FACEBOOK, GOOGLE+). The calendar application may combine the events from each of the user's calendars or accounts to show all the user's events included on each of the different services.

User interface 200 may include multiple regions. For example, user interface 200 may include header region 201, and event region 210.

Header region 201 may include the currently selected date 202. Currently selected date 202 may update as a user scrolls through event region 210. The currently selected date 202 may correspond to the topmost date in event region 210. Header region 201 may include a listing of dates 204, which may include an indication of the currently selected date 202 (e.g., a circle around the currently selected date). Header region 201 may include a “Today” button 205, which adjusts the currently selected date 202 to today's date in response to being selected.

Header region 201 may include other information, such as indication of current or forecasted weather (e.g., weather icon 203 may update or change to correspond to the current weather at the current location of the user).

Header region 201 may include other buttons for navigating to other areas of the calendar application. Header region 201 may include menu button 206 that may reveal a menu that allows other options to be adjusted (e.g., news feed, labels, settings, defaults, calendars, notifications, cache).

Header region 201 may include new event button 207 that may initiate an event creation process (e.g., go to a screen that allows a user to add a new event). Adding a new event may include adding information about an event (e.g., title, name, date, time, location, guests, description, whether the event is public or private, repeat, reminder, label, calendar). For example, event information may be stored in an event object similar to object 120 depicted in FIG. 1B.

Event region 210 may include a listing of events. The listing of events may include scheduled events already on the user's calendar. The listing events may include additional events recommended to the user. The listing of events may be scrollable or otherwise navigable by the user. For example, a user may be able to tap and drag the listing of events upwards or downwards, and the listing of events may correspondingly move into the future or past.

Each day on the listing of events in event region 210 may be divided into different days. Different days may be delineated by day listing 211. Day listing 211 may include a date and a corresponding day of the week. Day listing 211 may include an indication of a current day (e.g., “today”).

The listing of events may include multiple events 212. Each event 212 may be shown on a different line in the listing of events. Each event 212 may include a time of the event and a description of the event. The description of the event may include multiple details, such as an event name, location, attendees, details about the event, or the like. Each event 212 may include one or more pictures associated with the event. For example, if an event 212 is an event from a user's social-media calendar, the event 212 may display the picture associated with the event on the user's social-media account.

The calendar application may automatically detect that the same event is included on multiple calendars. The calendar application may detect the same event based on one or more criteria of the event being similar. For example, if a user has an event named “Work” from 9:00 am-5:00 pm on each of Monday through Friday on the user's personal calendar, and the user also has an event named “Work” from 9:00 am-5:00 pm on each of Monday through Friday on the user's work calendar, the calendar application may detect that the “Work” event corresponds to the same event, and only display one instance of the event named “Work.”

Events do not need to be identical for the calendar application to identify that they refer to the same event. For example, if the user's work calendar has an event named “Out of Office” from Thursday, Jun. 5, 2014, to Friday, Jun. 6, 2014, and the user's personal calendar has an event named “NYC trip” from Thursday, Jun. 5, 2014, to Friday, Jun. 6, 2014, the calendar application may determine that the “Out of Office” event on the work calendar corresponds to the “NYC trip” event on the personal calendar, and the calendar application may only show one, or a combination, of the two events.

The calendar application may indicate when an event is not shown because the event is determined to be a duplicate of another event. For example, the calendar application may show a special icon or other symbol to designate that the event shows up on multiple calendars, but is only listed once. In the illustrated embodiment, icon 214 may indicate that the “Work” event is on multiple calendars. For example, icon 214 has the number “2” inside a circle, so icon 214 may indicate that the “Work” event is on two calendars.

The calendar application may prompt or otherwise allow a user to designate two or more calendar events as being related to the same or different real-world events. For example, a user may be able to tap on icon 214 to view the “Work” event associated with each of the different calendars. The user may then be able to edit the “Work” event on the different calendars individually (e.g., remove the “Work” event from only one calendar). In another example, the user may be able to indicate that the merged events are not associated with the same event, and therefore should be displayed separately.

Event region 210 may include recommended events 213 inline with the listing of events. Recommended events may be individually listed, or may be grouped together as illustrated in FIG. 2. Recommended events may be grouped together based on similarities between the events (e.g., similar date, time, attendees, interest, type). A listing of recommended events 213 may include some indication of why the events are being recommended. For example, in FIG. 2, recommended events 213 include “Movie A, Concert B, and Party C are happening nearby.”

The user may select recommended events 213 to show more information about the recommended events. In one embodiment, the calendar application may show a new screen related to recommended events. In another embodiment, the calendar application may show a recommendation panel.

The system may include event notifications or reminders. For example, the calendar application may remind the user about an event. The reminding the user about the event may be triggered by a current time being within a threshold time range of a time of the event. The reminding the user about the event may be triggered by a current location of the user being within a threshold distance of a location of the event. The reminding the user about the event may be based on other factors, including a current date being within a threshold date range of a date of the event, a threshold number of attendees on an event guest list being reached, or some other factor. Any single factor, or a combination of multiple factors, may trigger an event notification or reminder.

The system may calculate a reminder based on other events on the user's calendar. For example, the system may determine an amount of time necessary to travel from the current location of the user to a location of the event. The system may set the threshold time range of the event to include at least the amount of time necessary to travel from the current location of the user to the location of the event. The threshold time range of the event may by dynamically adjusted as the user's current location changes. For example, in the morning, if the user is at home, five minutes away from an evening party, the threshold time for the reminder may be 15 minutes before the evening party. In the afternoon, if the user is at work 30 minutes away from home, the threshold time for the reminder may be 45 minutes before the evening party.

FIG. 3 shows an illustrative screen of the calendar application for showing recommended events. Events may be recommended based on one or more of a number of factors (e.g., current location, free time slots, likes, event history, social-media information, behavioral data, etc.).

Screen 300 may include a header region with buttons for performing actions within the application. For example, back button 301 may return the application to a previous screen (e.g., user interface 200). Current location button 302 may position the map 303 to center on the user's current location.

Map 303 may depict a user's current location. Map 303 may depict the locations of one or more recommended events. All recommended events nearby a user may be depicted on map 303, or only some recommended events may be depicted. For example, the recommended events depicted on map 303 may be limited to the recommended events 313 listed on screen 300. Alternatively, the recommended events depicted on map 303 may be additional events not in the list of recommended events, or may be on the list of recommended events but not currently shown on screen 300.

The list of recommended events 313 may be scrollable, and as a user scrolls through the list of recommended events 313, the recommended events depicted on map 303 may dynamically update to correspond to the shown recommended events 313. For example, as recommended events 313 scroll off the top of the list, they may be removed from map 303, and as new recommended events scroll onto the list (e.g., adding to the bottom of the list as the user scrolls), the new recommended events may be added to map 303.

Each recommended event 313 may include information about the recommended event 313. For example, the recommended event 313 may show a title, time, location, description, etc., for the event. The information displayed about the recommended event 313 may differ based on the type of event. For example, if the recommended event 313 is a movie, the recommended event 313 may show movie reviews, showtimes, rating, actors, awards, movie poster, screenshots, etc. In another example, if the recommended event 313 is a musical event, the recommended event 313 may show the band name, venue, concert time, band picture, venue picture, tour poster, etc. In another example, if the recommended event 313 is an event created by the user's contact (e.g., an event created on a social-media site by a contact of the user), the recommended event 313 may show the event title, how many contacts are going, location, time, etc.

The user may select a recommended event 313 to show more information about the event. The calendar application may show more information about the recommended event in a pop-up box, or may show in a new screen.

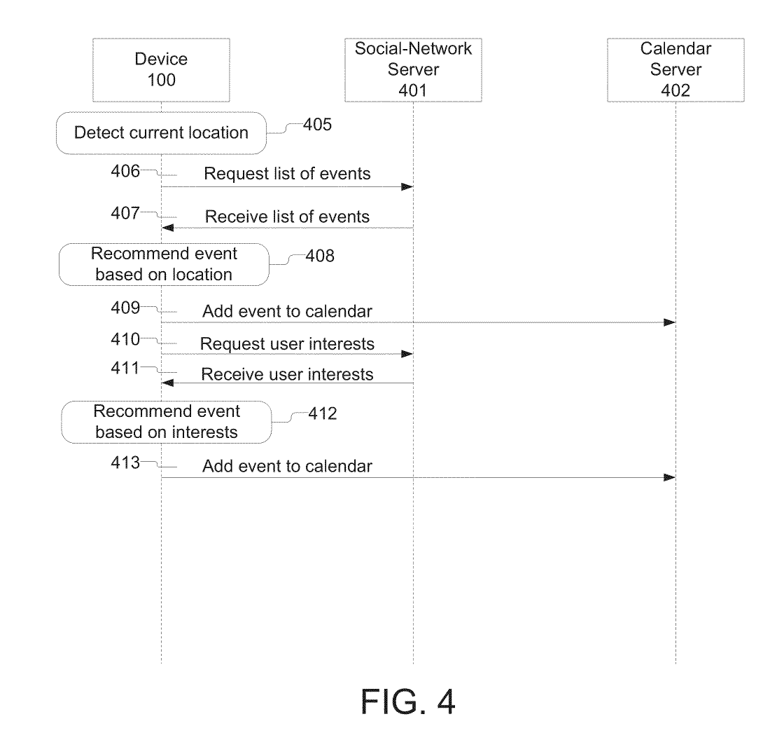

FIG. 4 shows an illustrative flow diagram of communications between computing device 100, social-network server 401, and calendar server 402. Social-network server 401 may be one or more servers associated with a social network (e.g., FACEBOOK). Calendar server 402 may be one or more servers associated with a calendar service (e.g., GOOGLE calendar, an enterprise calendar).

At step 405, computing device 100 may detect a current location of the user (e.g., the current location of computing device 100). For example, the computing device may use GPS, nearby wireless networks, internet protocol (IP) address, or a combination of other techniques known to one of skill in the art for detecting the current location of a device.

At step 406, computing device 100 may transmit a request for a list of events to a social network on which the user has a profile (e.g., social-network server 401). At step 407, computing device 100 may receive, in response to the request, the list of events from social-network server 401. The list of events may include events created or being attended by the user's contacts, organizations or persons the user is interested in or follows, events related to the user's interests, events nearby the user, and the like.

In some embodiments, computing device 100 may transmit a request for a list of events to another server. For example, a server may store events that have been handpicked by editors, events collected from event-listing websites via an application programming interface (API), events collected by known data-collection techniques (e.g., screen scraping), or other events. Computing device 100 may request events from a server that collects those events from other sources, or computing device 100 may request those events directly from those other sources. Computing device 100 may request a list of events from a single source, or may request a list of events from more than one source. If events received are duplicates of one another, computing device 100 may filter duplicates to only include one event of the duplicate events in the list of events.

The events may be filtered based on one or more factors. For example, the social-network server 401 may filter the events before sending the list of events to the computing device. Alternatively, the computing device 100 may filter the list of events, or another computing device or server may filter the list of events, then forward the filtered list to the computing device 100. Additional details about the factors for filtering events are included below.

In one example, computing device 100 may determine a location of each event of the list of events. Computing device 100 may request a location of each event from social-network server 401, which may transmit the location in response to the request. Alternatively, the event of the list of events may include metadata that includes the location of the event.

In one example, computing device 100 may determine one or more nearby events from the list of events within a threshold distance from the current location of the user by comparing the location of each event of the list of events to the current location of the user. For example, computing device 100 may filter the list of events received from the social-network server 401 to only include events within five miles of the user's current location. At step 408, computing device 100 may recommend one or more nearby events to the user. For example, computing device may recommend one or more events to the user based on the current location of the user. Computing device 100 may then receive, from the user, a selection of an event from the one or more nearby events. Computing device 100 may display additional information about the selected event to the user. The user may select one or more events to add to the user's calendar.

At step 409, computing device 100 may add the event to a calendar of the user. The calendar of the user may not be provided by the social network. For example, the calendar of the user may be an enterprise calendar provided by the user's employer. Calendar server 402 may receive the selected event from computing device 100, and add the selected event to the calendar of the user. Calendar server 402 may transmit a confirmation to computing device 100 that the selected event was added to the calendar of the user.

In some embodiments, computing device 100 may transmit a message to social-network server 401 that indicates that the user is attending the selected event. The social-network server may, for example, change the user's status on the event invite (e.g., from invited to attending). Computing device 100 may transmit additional information about the event to social-network server 401 (e.g., user comments on the event, user photos related to the event, additional contacts of the user that the user wants to invite to the event).

At step 410, computing device 100 may request user interests from social-network server 401. For example, the user may like a particular band, and may indicate that the user likes the particular band on the user's social-network profile. Social-network server 401 may, in step 411, transmit a list of the user's interests to computing device 100, and computing device 100 may receive the list of interests of the user from the social network (e.g., social-network server 401). The list of the user's interests may include the particular band.

Computing device 100 may filter the list of events received in step 407 by the user's interests. In other words, the list of events may be filtered based on multiple factors. In the illustrated example, the list of events may be filtered by location and by the user's interests. Computing device 100 may, in step 412, determine an event associated with an interest of the user from the list of interests of the user.

In some embodiments, determining the event associated with the interest from the list of interests of the user from the social network may include filtering a plurality of events respectively associated with the interests of the user to include events within the threshold distance of the current location of the user. For example, computing device 100 may recommend one or more events from the list of events based on the current location and the user's interests. For example, if the particular band is having a concert nearby the user's current location, computing device 100 may recommend the concert to the user.

The user may select one or more events from the list filtered using multiple factors (e.g., the list filtered using current location and user interests). At step 413, computing device 100 may add the event associated with the interest to the calendar of the user. For example, computing device 100 may transmit the selected one or more events to calendar server 402, similar to step 409. Calendar server 402 may receive the selected one or more events, and add the selected one or more events to the calendar of the user.

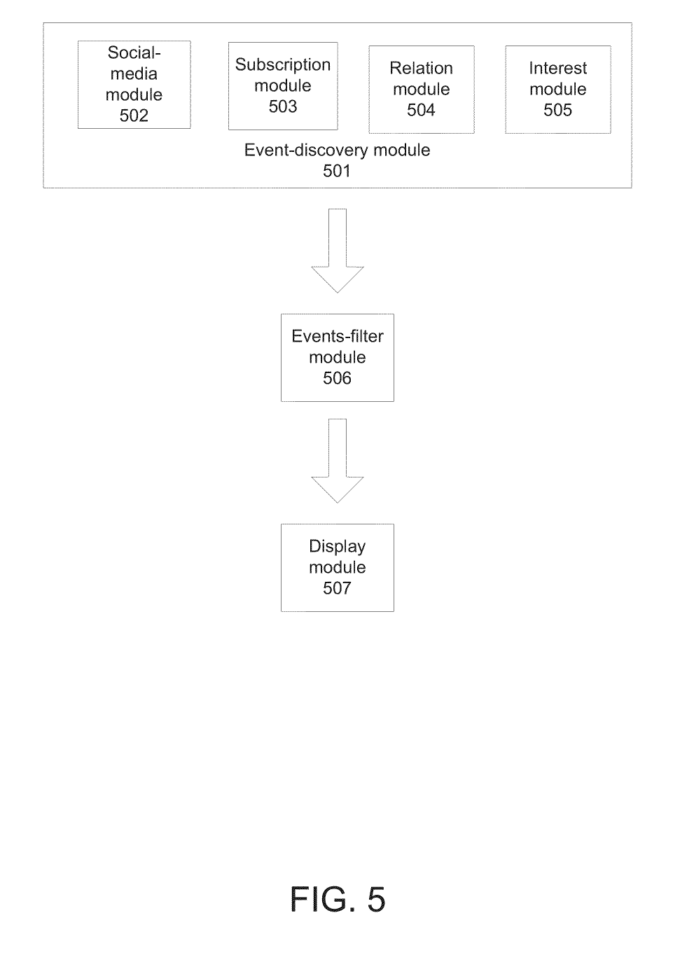

FIG. 5 shows an illustrative embodiment of a system and corresponding workflow for recommending events. System 500 may include event-discovery module 501, events-filter module 506, and display module 507. Event-discovery module 501 may include social-media module 502, subscription module 503, relation module 504, and interest module 505.

Each module may include executable code stored on memory 102 that, when executed by processor 101, causes computing device 100 to perform one or more steps. One or more modules may work in an offline mode. Each module may include storage (e.g., a database), or may share storage. One or more modules may be triggered by a user action.

Event-discovery module 501 may perform event discovery. Event discovery may be performed by one or more modules included within event-discovery module 501. Some event discovery may be performed by a single module, while other event discovery may be performed by multiple modules.

Social-media module 502 may connect to one or more social-media sites (e.g., FACEBOOK, LINKED IN, GOOGLE+) to receive information about a user from the social-media site. For example, social-media module 502 may retrieve information from a social-media site about a user's contacts, events attended by user's contacts (e.g., past events), events user has been invited to attend, user interests (e.g., user's “likes”), events associated with user interests, and the like.

Subscription module 503 may discover events based on a user's subscriptions. A user may subscribe to one or more categories of events. For example, if a user is interested in country music by singer Artist A, the user may subscribe to categories “music,” “country music,” and “Artist A.”

Subscription module 503 may sort, tag, or otherwise identify events as belonging to or being associated with one or more categories. For example, subscription module 403 may store events in different folders, tag events as being associated with one or more categories, index events as being part of one or more categories, etc. An event may be tagged with more than one category (e.g., a concert by country-music artist Artist A may be tagged with the categories “music,” “country music,” and “Artist A”). A category may include one or more events (e.g., the “music” category may include concerts by Artist A and Artist B).

Relation module 504 may recommend events based on relationships within the event-recommendation system. For example, the relation module 504 may recommend events based on the user's friends, contacts, etc., within the event-recommendation system. The relation module 504 may recommend events based on events, for example, that the event-recommendation system has previously recommended, the user previously attended, the user's contacts previously attended, etc.

Interest module 505 may determine a user's interests to suggest events that the user may be interested in. Interest module 505 may implement multiple processes to discover events that the user may be interested in.

One process for discovering events that the user may be interested in may include an algorithm based on the idea that more common events have more common audiences. For example, event A and event B may have attendees in sets s(A) and s(B). The similarity of attendees between s(A) and s(B) may be w(A, B):

$$w ( A , B ) = s ( A ) s ( B ) \frac{\vert s ( A ) ⋂ s ( B ) \vert}{\sqrt{\vert s ( A ) \vert \vert s ( B ) \vert}}$$

Once a user has added event A (e.g., added event A to user's calendar, RSVP'd to event A, joined event A on a social-media site), interest module 505 may add a number of top n similar events to other events the user may be interested in (e.g., recommended events).

Another process for discovering events that the user may be interested in may include extracting key information from event-source data (e.g., names of attendees or organizers, band, title, address, location, venue, attendees, organizer, title, description, emphasized phrases, repeated phrases). After extracting key information, interest module 505 may assign or associate each event with a list of key information. The module may index key information in two indexes. A first index may include key information about each event. A second index may include events associated with key information. Thus, interest module 505 may easily retrieve information about each event, or events associated with key information (e.g., events with a key phrase, location, type, etc.).

Events discovered by the event-discovery module 501 (e.g., events discovered by social-media module 502, subscription module 503, relation module 504, or interest module 505) may be stored in storage 103, or one or more storage servers or other computing devices connected to network 110. Event-discovery module may transmit an indication to event-filter module 506 that one or more events have been discovered or stored by event-discovery module 501.

Event-filter module 506 may filter events based on one or more factors (e.g., a user's current location, a user's free time slots). Event-filter module 506 may build geohash or r-tree data structures to index information about an event (e.g., location, title). Event-filter module 506 may build a b-tree data structure to index other information (e.g., time).

Event-filter module 506 may use a user's location and time slots to filter events and generate recommended events. A user's profile may store the user's current location. Alternatively, the user's profile may store a location specified by the user. The event-recommendation system may retrieve the user's free time slots by removing time slots occupied by events that a user has already joined.

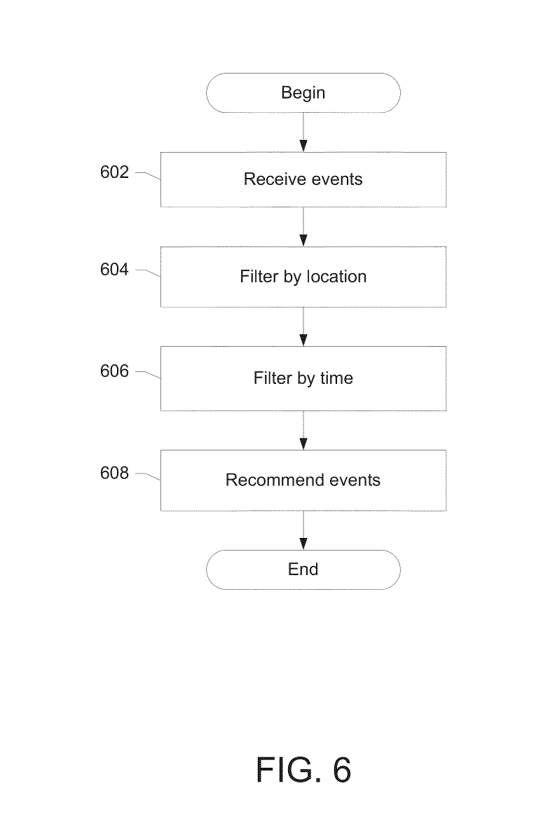

FIG. 6 shows an illustrative flowchart for one process by which the event-recommendation may recommend events to a user. Specifically, the process depicted in FIG. 6 may be performed by events-filter module 506 for filtering events to recommend to a user.

In step 602, the system may receive events. The system may receive a list of events, an array or other package of events, access a database containing events, etc. For example, events-filter module 506 may receive events from event-discovery module 501.

In step 604, the system may filter the events by location. The system may use the current location of a user, a location specified by the user, a location of another event (e.g., the location of an event that the user is attending before or after the potentially recommended event), a location of a contact of a user (e.g., the location of the user's spouse), etc. The system may filter the events received in step 602 to only include events within a certain threshold distance of the location being used for filtering.

In step 606, the system may filter the events by time. For example, the system may detect available times in the user's calendar. The system may determine times that the user has appointments in the user's calendar, and based on the times that the user has appointments in the user's calendar, determine times that the user is available. For example, times that the user does not have appointments in the user's calendar may be times that the user is available. The system may determine a user's availability based on the user's typical schedule. For example, if the user typically goes to work Monday through Friday from 9:00 am to 5:00 pm, the system may determine that the user is not available during those times. If the user does not have an appointment in the user's calendar during the time that the user typically has something scheduled (e.g., the user does not have a calendar event for “work” one day), the system may determine that the user is not available during that time based on the user typically having something scheduled during that time.

The system may prompt a user to determine if the user is available at a certain time. For example, the system may detect that the user does not have an event scheduled at a time that the user typically has an event scheduled, and may, in response to detecting that the user does not have an event scheduled at the time that the user typically has an event scheduled, prompt the user to determine whether the user is available to go to one or more events during the time.

The system may determine a user's availability based on changes in the user's schedule. For example, if the user previously had an event at a certain time, and the event was later deleted or the time was changed, then the system may determine that the user is now available at the time previously occupied by the scheduled appointment.

In step 608, the system may recommend events to the user. The system may recommend events to the user by showing the events inline in the user's calendar, in a recommended events line or screen on a calendar application, via a notification (e.g., email, short message service (SMS), text message), phone call, voicemail, etc.

A user may accept, decline, or mark an event as tentative. If the user accepts an event, the system may add the event to one or more calendars of the user. The system may notify an organizer of the event that the user has accepted the event (e.g., the user will be attending the event).

If the user declines an event, the system may remove the event from the user's recommended events. The system may track events accepted or declined by the user, and recommend or not recommend future events based on the user's accepting or declining the event.

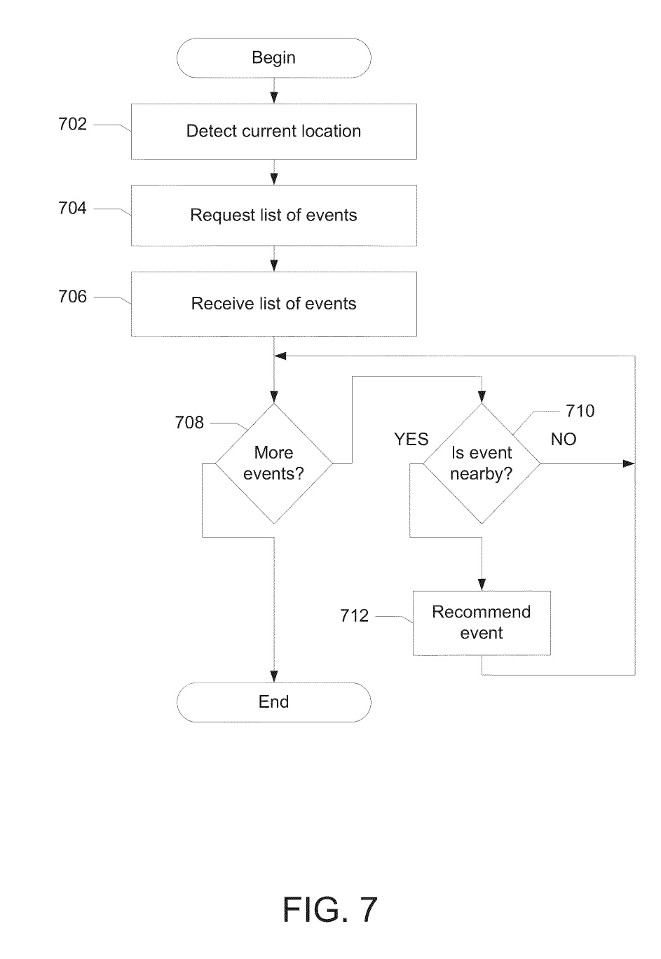

FIG. 7 shows an illustrative flow chart of a process that the system may perform for recommending events to a user based on the user's current location.

In step 702, the system detects the current location of the user. For example, the system may determine the user's current location using a GPS radio, Wifi, IP address, the native location-detection features of a smartphone (e.g., a software development kit for a mobile operating system), etc.

In step 704, the system may request a list of events. For example, the system may request a list of events from a social network, an event organizer, a calendar, an event database, a contact of the user, etc. In step 706, the system may receive the requested list of events.

In step 708, the system may check if there are any events remaining in the list of events received in step 704. If there are more events remaining, in step 710, the system may determine if one of the events on the list is nearby the current location of the user. For example, the system may determine if the event is within a threshold distance of the user (e.g., if the event is within 2 blocks, ½ mile, 1 mile, 1 kilometer, 5 kilometers, 10 minutes, 30 minutes). There may be a different threshold based on the type of event, the time of day, day of the week, a setting by the user, etc. If the event is within the threshold distance, in step 712, the system may recommend the event to the user, who may then accept, decline, or mark the event as tentative. If the event is not within the threshold distance, the system may remove the event from the list of events, and check in step 708 if there are any more events remaining on the list of events.

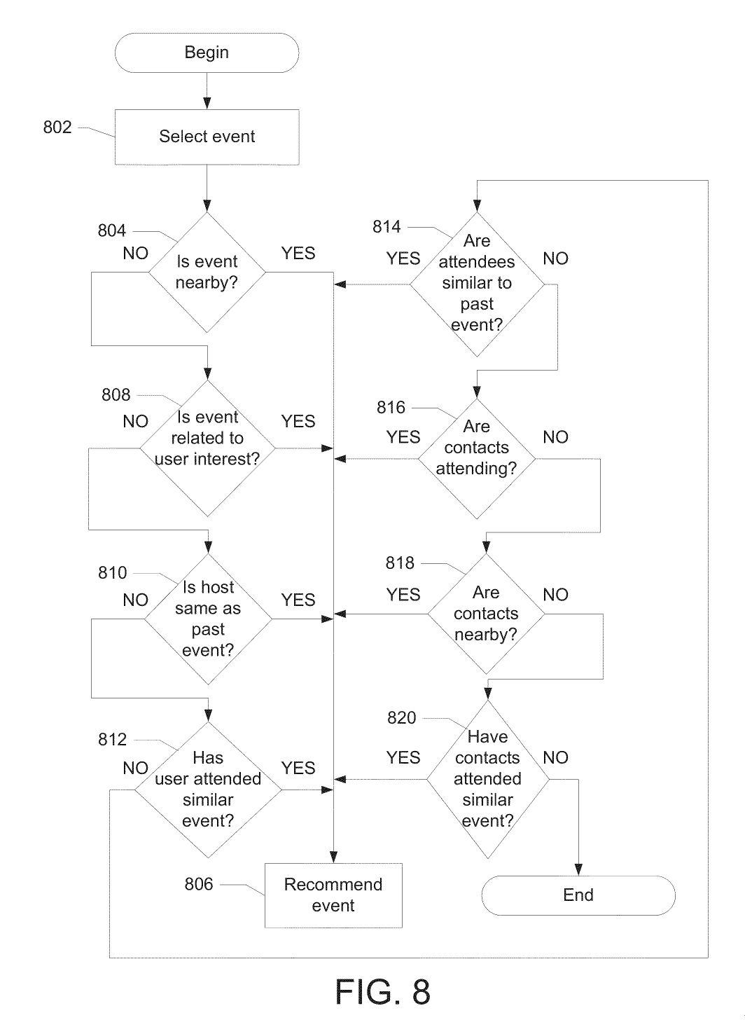

FIG. 8 shows an illustrative flow chart of a process that the system may perform for determining whether to recommend an event to a user based on a number of different factors. The illustrated flowchart shows the process for evaluating a single event for whether to recommend the event to the user. For example, the process may be performed by events-filter module 506.

In one embodiment, the system may compare details about an event to details about one or more past events attended by the user. The system may recommend the event to the user based on detecting at least one similarity in the details about the event and the details about the one or more past events attended by the user. Below is included discussion of some of the potential details used by the system to detect similarity between an event and one or more past events attended by the user.

When evaluating an event based on multiple factors, the system may only require that one factor be satisfied to recommend an event (e.g., any one of a number of factors). Alternatively, the system may only recommend an event if multiple or a certain number of factors are met (e.g., at least two of a number of factors, at least three of a number of factors). Alternatively, the system may only recommend an event if certain factors are met (e.g., the event is nearby and the user is interested in the category of the event). Alternatively, the system may recommend an event based on any number of a number of different factors. Further, the system may use different rules for evaluating different factors based on additional factors (e.g., the system must meet at least three factors if the event is at time A, while the system must meet only one factor if the event is at time B). The system may weight different factors differently (e.g., an event attended by a user's spouse may more likely to be recommended than an event nearby the current location of the user). In the example depicted in FIG. 8, the system may recommend an event if any one factor is met.

In step 802, the system may select an event (e.g., from a list of events). For example, the system may have received a number of events from, for example, event-discovery module 501, and the system may select one of those received events.

In step 804, the system determines if the event is nearby a current location of the user (e.g., similar to step 710 of FIG. 7). If the event is nearby the user, the system may recommend the event in step 806. If the event is not nearby the user, the system may go to step 808.

In step 808, the system may determine if the event is related to an interest of the user. The system may obtain the user's interests from a social network, from the user's web history, cookies stored on the user's computing device, the user's email, text, or other communications, the type or category of events that the user attends, a user's indication of events (e.g., in a user profile), places visited by the user (e.g., checkins), or another way. The system may compare one or more categories of the event to the user's interests. If the event matches at least one category of the user's interest, the system may recommend the event to the user in step 806.

In some examples, the system may resolve a conflict with the user's interests and an event. For example, if an event corresponds to an interest of the user and a disinterest of the user, the system may arbitrate the event recommendation. For example, the system may prompt the user. The system may determine whether to recommend the event based on a hierarchy of interests of the user (e.g., recommend certain types more often than others, don't recommend other types of events). The system may determine whether to recommend the event based on a blacklist of event categories. For example, if a user enjoys music concerts, but does not enjoy events at venue Y, then even if a music concert is happening at venue Y, the system may determine that because the user does not like events at venue Y, the system may not recommend the event to the user. If the system does not recommend the event to the user, the system may go on to step 810.

In step 810, the system may determine if the host of the event is the same as the host of a past event attended by the user. The system may determine a relationship of the user to the host of the event. The system may determine based on the relationship of the user to the host of the event whether to recommend the event to the user. For example, if the host of an event is the user's spouse, then the event recommendation system may determine that because a spouse is a close relationship, the user likely wishes to attend the event, and may recommend the event.

The system may have trusted relationships set up between the user and the user's contacts. Based on relationships between the user and contacts of the user, the system may automatically add events hosted by certain contacts of the user to a calendar of the user. For example, if a user's spouse is a host, an the user's spouse has been added as a trusted relationship, then an event hosted by the user's spouse may be automatically added to the user's calendar.

If the system determines that the host of the event is the same as the host of a past event attended by a user, the system may recommend the event in step 806. Otherwise, the system may go on to step 812.

In step 812, the system may determine if the user has attended a similar event in the past. The system may examine the user's calendar, a database of events attended by the user, information received from a social network, server, database, or other source. The system may compare information about the event to past events to determine if the events are similar (e.g., titles, names, category, description). For example, if the event is a football home game being played by the user's favorite team, Team R, and the user has attended Team R home games in the past, then the system may recommend the event. If the system determines that the user has attended similar events in the past, the system may recommend the event in step 806.

In one embodiment, determining if the user has attended a similar event in the past may include determining if there is a similarity between an event category of the event and an event category of one or more past events attended by the user. If the event of the plurality of events and the one or more past events attended by the user are each associated with the same event category, the system may recommend the event.

If the event and past events attended by the user are not, however, in or associated with the same event category, the system may go on to step 814.

In step 814, the system may determine if the attendees of the event are similar to a past event attended by the user. The system may examine, as in step 812, past events attended by the user. In examining past events attended by the user, the system may compare the attendees of past events attended by the user to the guest list (e.g., RSVP list) of the selected event. The system may weight different attendees differently. For example, the system may be more likely to recommend an event if an individual with a close relationship with the user (e.g., spouse) is attending the event than if an individual with a more distant relationship with the user is attending the event. For example, the system may examine the number of overlapping events attended by the user and the attendee or attendees of the event. For example, if a contact of the user with whom the user has attended ten events is attending the event, the system may be more likely to recommend the event than if a contact of the user with whom the user has attended one event is attending the event. If one or more attendees are similar to past events attended by the user, then the system may recommend the event in step 806. Otherwise, the system may go on to step 816.

In step 816, the system may determine if contacts of the user are attending the event. In some embodiments, the processes of step 814 and 816 may be similar, or combined into a single step. The system may retrieve a list of contacts of the user, compare the list of contacts of the user to a list of attendees of each of a plurality of events (e.g., the event), and recommend the event based on one or more of the contacts of the user being the attendees of the event. The system may recommend the event if any contacts of the user are attending the event, even if the user has never attended an event with one of those contacts before. For example, if a user meets a new co-worker, and adds the new co-worker to the user's contact list, then the system may determine if the new co-worker is attending the selected event in order to determine whether to recommend the selected event to the user. If the system determines that one or more contacts of the user are attending the event, the system may recommend the event in step 806. Otherwise, the system may go on to step 818.

In step 818, the system may determine if any contacts of the user are nearby the user's current location. The system may retrieve the user's current location, or use the user's current location retrieved in step 804. The system may retrieve current locations of contacts of the user. The system may compare the user's current location with the locations of the contacts of the user. If the current location of one or more contacts of the user are nearby the user's current location and the location of the selected event, the system may recommend the event in step 806. Otherwise, the system may go on to step 820.

In step 820, the system may determine if one or more contacts of the user have attended a similar event. The system may retrieve contacts of the user, and retrieve past events attended by the contacts of the user. The system may compare the selected event to the past events attended by the contacts of the user. For example, if the user has never attended a concert by Band F before, but one or more contacts of the user have attended a concert by Band F, the system may recommend an event that is a concert by Band F. Thus, if the system determines that the one or more contacts of the user have attended a similar event to the selected event, the system may recommend the event in step 806. Otherwise, the system may not recommend the event. If the system does not recommend the event, the system may remove the event from the list, database, or other collection of events that the system may consider recommending to the user.

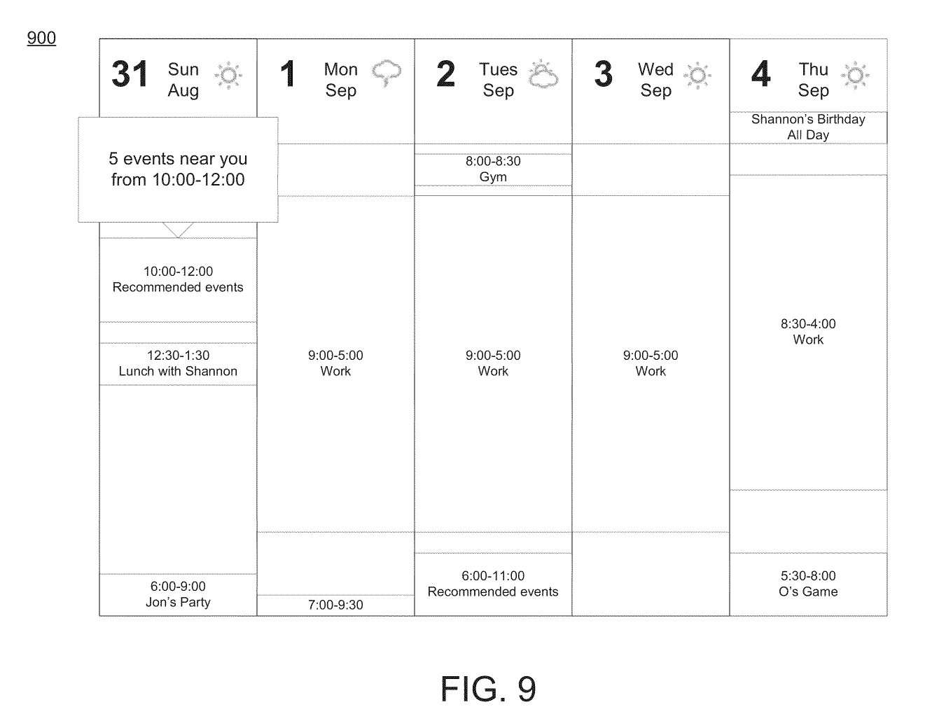

FIG. 9 shows an illustrative embodiment of the event-recommendation system. FIG. 9 illustrates an interface for a calendar of a user that includes event recommendations inline with the calendar. Interface 900 may be shown on a computing device, web browser, an application on a tablet, an application on a desktop, etc. Interface 900 may include information about each specific day across the top of the calendar, including the day of the week, date, month, year, weather forecast, etc.

Interface 900 may include one or more portions representing a user's schedule for each day. For example, FIG. 9 illustrates five days—Sunday through Thursday—each with a column representing a period of time during that day. Each day may include one or more scheduled events for that day. Each scheduled event may include information about the scheduled event, including time, title, description, location, other attendees, or other information about the scheduled event. Some scheduled events may be all-day events, which may be shown at the top of the column representing a day during which the all-day event takes place.

In one embodiment, the system may show a list of the recommended plurality of events in a portion of the calendar of the user. In other words, the system (e.g., interface 900) may show event recommendations inline in a user's calendar, after calculating one or more recommended events as described herein.

The system may detect one or more time slots on the calendar of the user, and filter the list of the recommended plurality of events to only include events occurring during the one or more available time slots. For example, the system may limit event recommendations to available time slots on a user's calendar. The system may recommend events in groups based on the free time slots in a user's calendar. For example, interface 900 shows recommended events on Sunday, August 31, from 10:00-12:00, and other recommended events on Tuesday, September 2, from 6:00-11:00.

Interface 900 may show a pop-up with more information about one or more recommended events in response to a user selection of recommended events shown inline with a user's calendar. For example, as illustrated in FIG. 9, a user may have selected the recommended events from 10:00-12:00 on Sunday August 31, and the system then shows a pop-up box with more information about the recommended events (i.e., there are five recommended events near the user). The user may click on the pop-up box for more information about recommended events, scroll through the pop-up box for more information, or otherwise obtain more information about recommended events.

The system may receive a selection of a recommended event from a list of a plurality of recommended events. The system may add the selected event to the calendar of the user. The system may transmit a message confirming attendance of the user to the event, for example to a social network, computing device, server, or other computing device associated with the event. The user may then be added to a guest list of the event.

The system may invite one or more contacts of the user to attend the event. Inviting one or more contacts of the user may be performed automatically, without user intervention, in response to receiving the selection of the recommended event by the user. An invitation to a contact of the user to attend the event may be sent via email, SMS message, text message, postal mail, an app notification, or some other notification.

The user may make the user's attendance at an event conditional on the attendance of one or more contacts of the user. For example, the user may indicate that the user is tentative about attending the event, but that the user will attend the event if the user's spouse attends the event. The system may invite the user's spouse to the event. If the user's spouse decides to attend the event (e.g., accepts the invitation to attend the event), then the system may automatically adjust the user's response to the event to also indicate that the user is attending the event.

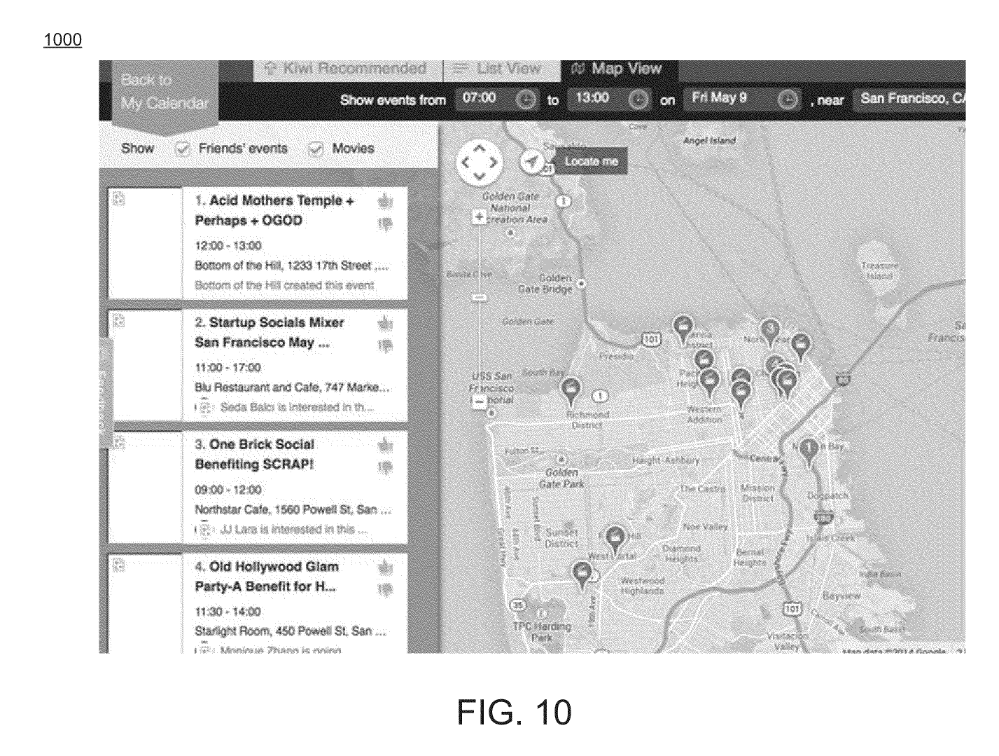

FIG. 10 shows an illustrative embodiment of the event-recommendation system. FIG. 10 illustrates a desktop or web interface that implements an event-recommendation system (e.g., interface 1000).

Interface 1000 may include tabs across the top for navigating to different views. For example, tabs may include recommended events in list view or in a map view. A list view may include a listing of recommended events. A map view may include a map showing the location of one or more recommended events, as shown in FIG. 10.

The map in interface 1000 may include one or more recommended events. Events may include events of the same or similar types, or events of different types. A user may have the option to turn on or off pre-defined filters that filter the map to only show events of a certain type (e.g., friends' events, movies). The interface 1000 may also include a portion that allows the user to enter criteria for filtering events (e.g., show events during a certain time or range of time, on a certain date or range of dates, at or near a certain location, within a certain distance).

The map may allow the user to see the user's current location. For example, the map may include a button that, when pressed, causes the map to automatically center on or show the user's current location. The user may be able to drag or move the map around to see different places on the map. The list of recommended events may automatically refresh to show events corresponding to the locations currently shown on the map, while the map may refresh to show markers for events at locations currently shown on the map, including those locations shown on the refreshed list of recommended events.

The map view may include a list of recommended events on a portion of the map (e.g., a side, the top, the bottom). The events in the list may correspond to event-location markers shown on the map. Event-location markers on the map may include an indication of what event in the list of recommended events each event-location marker corresponds to. For example, the marker corresponding to the first event in the list may include the number “1,” the marker corresponding to the second event in the list may include the number “2,” etc.

Each event in the list of recommended events may include information about the event. For example, each event in the list of recommended events may include one or more of a picture, a title, a time, a location, a creator, a host, individuals interested in the event.

A user may be able to indicate interest or disinterest in the event on the list of events. For example, each event in the list of recommended events may have an interest or disinterest button (e.g., thumbs up, thumbs down). If a user indicates interest in an event, the event-recommendation system may show the user more events like that event, save the event for later consideration by the user, recommend that event to contacts of the user, recommend events like that event to contacts of the user, or otherwise alter the event-recommendation system to include the user's interest in that event.

Similarly, if the user indicates disinterest in the event, the event-recommendation system may remove the event from the list of recommended events, show the user fewer events like that event, not recommend that event to contacts of the user, not recommend that event to contacts of the user, not recommend events like that event to contacts of the user, or otherwise alter the event-recommendation system to include the user's disinterest in that event.

Although example embodiments are described above, the various features and steps may be combined, divided, omitted, rearranged, revised, or augmented in any desired manner, depending on the specific outcome or application. Various alterations, modifications, and improvements will readily occur to those skilled in art. Such alterations, modifications, and improvements as are made obvious by this disclosure are intended to be part of this description though not expressly stated herein, and are intended to be within the spirit and scope of the disclosure. Accordingly, the foregoing description is by way of example only, and not limiting. This patent is limited only as defined in the following claims and equivalents thereto.

What is claimed is:

1. A method comprising:
detecting, by a computing device, a current location of a user;
transmitting a request for a list of events to a social network on which the user has a profile;
receiving, in response to the request, the list of events from the social network;
determining a location of each event of the list of events;
determining one or more nearby events from the list of events within a threshold distance of the current location of the user by comparing the location of each event of the list of events to the current location of the user;
recommending the one or more nearby events to the user;
receiving, from the user, a selection of a first event from the one or more nearby events; and
adding the first event to a calendar of the user, wherein the calendar is not provided by the social network.

2. The method of claim 1, comprising:
receiving a list of interests of the user from the social network;
determining a second event associated with an interest from the list of interests of the user;
recommending to the user the second event associated with the interest from the list of interests of the user; and
adding the second event associated with the interest to the calendar of the user.

3. The method of claim 2, wherein determining the second event associated with the interest from the list of interests of the user from the social network comprises filtering a plurality of events respectively associated with the interests of the user to include events within the threshold distance of the current location of the user.

4. The method of claim 1, comprises:
comparing details about the event of the plurality of events to details about one or more past events attended by the user; and
recommending the event of the plurality of events based on detecting at least one similarity in the details about the event of the plurality of events and the details about the one or more past events attended by the user.

5. The method of claim 4, wherein the details of the event of the plurality of events and the details of the one or more past events attended by the user comprise an event category, wherein the event of the plurality of events and the one or more past events attended by the user each are associated with the event category.

6. The method of claim 4, wherein the details of the event of the plurality of events and the details of the one or more past events attended by the user comprise an interest of the user, wherein the event of the plurality of events and the one or more past events attended by the user each are associated with the interest of the user.

7. The method of claim 4, wherein the details of the event of the plurality of events and the details of the one or more past events attended by the user comprise a host of the event, wherein the event of the plurality of events and the one or more past events attended by the user each are hosted by the host.

8. The method of claim 4, wherein the details of the event of the plurality of events and the details of the one or more past events attended by the user comprise one or more people attending, wherein one or more people attending the event of the plurality of events attended the one or more past events attended by the user.

9. The method of claim 1, wherein recommending the event of the plurality of events comprises recommending the event based on one or more past events attended by one or more contacts of the user.

10. The method of claim 1, comprising:
retrieving a list of contacts of the user;
comparing the list of contacts of the user to a list of attendees of each of the plurality of events; and
recommending the event based on one or more of the contacts of the user being the attendees of the event.

11. The method of claim 1, comprising:
detecting respective current locations of one of more contacts of the user; and
recommending the event based on a location of the event being similar to the current location of the user and the respective current locations of the one or more contacts of the user.

12. The method of claim 1, comprising:
showing a list of the recommended plurality of events in a portion of the calendar of the user; and
receiving a selection of the event from the list of the plurality of events.

13. The method of claim 12, comprising:
detecting one or more available time slots of the calendar of the user; and
filtering the list of the recommended plurality of events to only include events occurring during the one or more available time slots.

14. The method of claim 1, comprising:
transmitting a plurality of requests for a list of events to a respective plurality of social networks on which the user has a profile.

15. The method of claim 1, comprising:
transmitting a message confirming attendance of the user to the event; and
adding the user to a guest list of the event.

16. The method of claim 1, comprising:
reminding the user about the event,
wherein the reminding the user about the event is triggered by a current time being within a threshold time range of a time of the event.

17. The method of claim 16, comprising:
determining an amount of time necessary to travel from the current location of the user to a location of the event; and
setting the threshold time range of the event to include at least the amount of time necessary to travel from the current location of the user to the location of the event.

18. The method of claim 1, comprising:
inviting one or more contacts of the user to attend the event.

19. A non-transitory computer-readable medium storing computer-readable instructions that, when executed, cause a device to:
detect a current location of a user;
transmit a request for a list of events to a social network on which the user has a profile;
receive, in response to the request, the list of events from the social network;
determine a location of each event of the list of events;
determine one or more nearby events from the list of events within a threshold distance of the current location of the user by comparing the location of each event of the list of events to the current location of the user;
recommend the one or more nearby events to the user;
receive, from the user, a selection of a first event from the one or more nearby events; and
add the first event to a calendar of the user, wherein the calendar is not provided by the social network.

20. A system comprising:
one or more processors; and
non-transitory computer-readable memory storing computer-readable instructions that, when executed by the one or more processors, cause the system to:
detect a current location of a user;
transmit a request for a list of events to a social network on which the user has a profile;
receive, in response to the request, the list of events from the social network;
determine a location of each event of the list of events;
determine one or more nearby events from the list of events within a threshold distance of the current location of the user by comparing the location of each event of the list of events to the current location of the user;
recommend the one or more nearby events to the user;
receive, from the user, a selection of a first event from the one or more nearby events; and
add the first event to a calendar of the user, wherein the calendar is not provided by the social network.
